(19) United States
(12) Patent Application Publication
(10) Pub. No.: US 2010/0243612 A1
(43) Pub. Date: Sep. 30, 2010

(54) ELECTRICAL DISCHARGE MACHINING

(75) Inventors: Fabio N. Leao, Derby (GB); Alexander Xidacis, Derby (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/744,502

(22) PCT Filed: Nov. 5, 2008
(86) PCT No.: PCT/GB08/03716

§ 371 Date: May 25, 2010

(30) Foreign Application Priority Data
Dec. 4, 2007 (GB) 0723666.4

(51) Int. Cl. B23H 7/38; B23H 9/14

(52) U.S. Cl. 219/69.17; 219/69.2

(57) ABSTRACT

Processing of components such as turbine blades for gas turbine engines requires formation of holes and other shaping. It is known to use electrical discharge machining processes to produce such holes and apertures in work pieces. Removal of debris is important to avoid short circuiting and/or arcing and to allow rapid processing. Utilisation of high pressure dielectric fluid flow reduces debris build up but can still result in short circuit switching or interrupt continuous processing. By provision of vibration and in particular ultrasonic vibration cavitation is induced within the pressurised dielectric fluid flow to enhance debris removal and therefore improve continuous machining processes.

The present invention relates to electrical discharge machining and more particular to so-called high speed electrical discharge machining (HSEDM) utilised for forming holes in such components as blades for gas turbine engines.

Electrical discharge machining is utilised with regard to processing of work pieces by spark erosion. The work piece and the electrode are generally presented with a dialectic fluid between them such that by periodic pulses of electric energy spark erosion occurs in order to erode the work piece and so create a cavity or hole or otherwise shape a work piece. In order to provide for spark erosion, the work piece and the electrode must have no physical contact and a gap is maintained typically through appropriate sensors and servo motor control. It will be understood that erosion debris must be removed from the erosion site and this usually necessitates a retraction cycle during conventional electrical discharge machining.

An alternative is so-called high speed electrical discharge machining (HSEDM). In high speed electrical discharge machining a high pressure dielectric fluid pump is utilised in order to maintain a pressure in the order of 70 to 100 bar in the dielectric fluid presented in the gap between the work piece and the electrode. As a result of the high pressure presentation of the dielectric fluid the process is much more efficient than conventional electrical discharge machining (EDM) allowing more rapid removal of debris such that erosion rates are far greater. It will also be appreciated with high speed electrical discharge machining it is possible to utilise multiple electrodes in a single tool holder to allow several erosion and machining processes to be performed at the same time and normally side by side. With high speed electrical discharge machining there is no need for retraction cycles between stages of erosion for evacuation of debris as the high pressure flow of dielectric fluid in the gap between the work piece and the electrode is more efficient for the removal of debris produced by the erosion process. With high speed electrical discharge machining generally the electrode is simply fed forwards at a speed necessary to achieve the desired rate of material erosion and removal in accordance with the machining process. It will be appreciated continuous operation results in a significantly faster machining process.

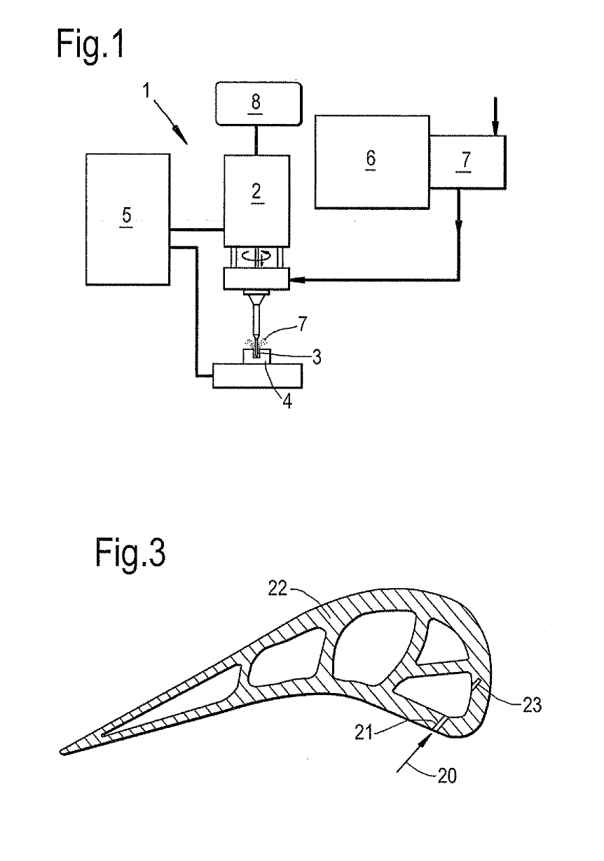

In the attached drawings FIG. 1 schematically illustrates a typical high speed electrical discharge machining arrangement. The arrangement 1 comprises an electrode holder 2 which presents an electrode 3 to a work piece 4. Electrical discharge is provided through a generator 5 such that a cavity or hole is drilled or formed or machined into the work piece 4. In accordance with high speed electrical discharge machining dielectric fluid is presented at a relatively high pressure (70 to 100 bar) within the cavity or hole defined progressively by a gap between the electrode 3 and the work piece 4. This high pressure dielectric flow is achieved through a pump 6 which stimulates a dielectric fluid supply 7 to force the dielectric fluid under pressure as indicated in the gap between the electrode 3 and the work piece 4. Such high pressure flushes and removes debris caused by the discharge process. As indicated above a servo motor 8 or other device forces continuous movement of the electrode 3. By monitoring the gap voltage the servo motor 8 can maintain a gap of constant size. If there is successive accumulation of debris in the gap, the motor 8 will retract the electrode 3 to avoid short circuits. However, due to the high pressure dielectric fluid flow there is rapid removal of debris and therefore generally it is not necessary to have a retraction cycle of the electrode in order to allow flushing as with conventional electrical discharge machining. In such circumstances in the normal course of events the servo motor 8 will simply move the electrode down at whatever speed is necessary to keep up with the desired rate of material removal and/or erosion. The constant motion of the servo motor 8 allows for rapid drilling but if drilling is too rapid there is an increased likelihood of short circuiting. In such circumstances the servo motor 8 retracts to allow clearing of the electrical short circuits and debris as well as to eventually re-establish the correct gap size for erosion.

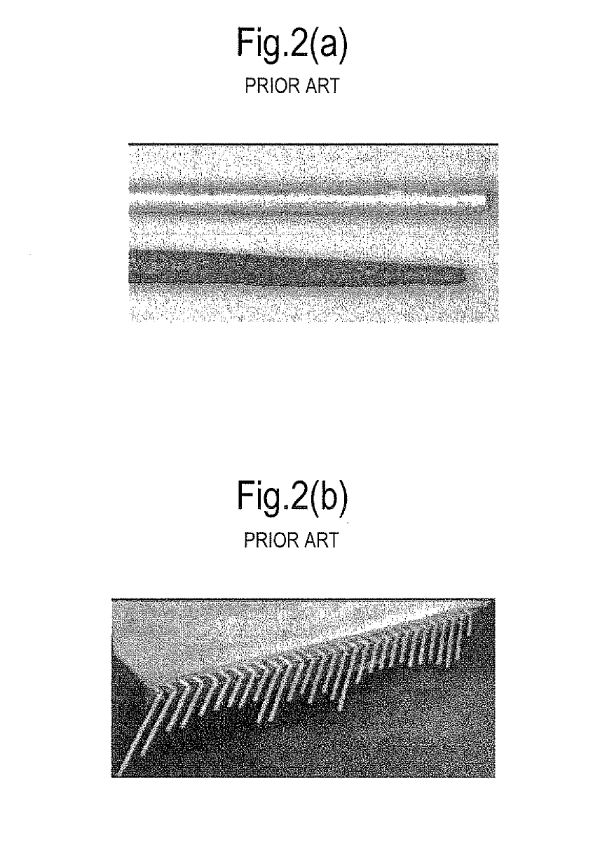

High speed electrical discharge machining and in particular drilling has been used with respect to forming holes and other features in turbine blades for gas turbine engines. These components such as turbine blades have very strict requirements with regard to the hole geometry and surface integrity. However, high speed electrical discharge machining is subject to high production costs and has large variations in typical break through time to form a hole, electrode wear and necessity for re-working of components. It is not uncommon to have relative electrode wear factors greater than 100%, that is to say it is necessary to erode a greater length of electrode than depth of drilling or erosion. Such factors also add to production complexity. It will be appreciated that high speed electrical discharge machining as indicated is inconsistent and relatively unpredictable resulting in large variations in cycle times and electrode wear whether that be longitudinal, tapered or differential as depicted in FIG. 2 marked “Prior Art”. Continual running of processes in such circumstances depends upon operator practical experience and interventions at appropriate times by such highly skilled operators being used.

With regard to single electrodes it is common for the electrode to taper as a result of the electrical discharge machining process. With multi electrode tools used with high speed electrical discharge machining it is also known in addition to tapering wear of the electrode for the individual electrodes to differentially wear. In such circumstances electrodes that become tapered produce tapered holes with a restriction at an exit end. Uneven electrodes in a multiple electrode tool will result in some electrodes not fully penetrating the work piece and breaking through leaving blocked holes. Furthermore, if the servo motor needs to feed the electrodes deeper to complete the hole formation the excess electrode length in some of the multi electrodes may in many cases provoke back wall impingement erosion and so damage other parts of the component. Such back wall impingement erosion is illustrated in FIG. 3. As can be seen a hole 21 is drilled in the direction 20. If the electrode passes through the hole 21 and continues to erode a component 22 there will be back wall impingement erosion 23. Although high speed electrical discharge machining is advantageous there may still be problems with regard to holes drilled with relatively large length to diameter ratios.

In accordance with aspects of the present invention there is provided a method for electrical discharge machining comprising presenting an electrode to a work piece with a gap between them to achieve erosion by electrical discharge, the gap filled with a dielectric fluid at a pressure in the range of 70 to 100 bar, the electrode and/or the work piece displaceable to maintain the gap as the electrode wears and the work piece is machined in use, the method characterised in that an assembly of the work piece and/or the electrode and/or the dielectric fluid are subject to vibration to provoke cavitation within the dielectric fluid in the gap.

Alternatively, in accordance with aspects of the present invention there is provided an electrical discharge machining arrangement comprising an electrode, an electrode piece holder, a drive mechanism to maintain a gap between the electrode and the work piece in the work piece holder in use, a dielectric source arranged to present a dielectric fluid flow in the gap and maintain the dielectric fluid at a pressure of 70 to 100 bar in the gap, the arrangement characterised in that the arrangement includes a vibration source to present vibration excitation to an assembly of the work piece and/or the electrode and/or dielectric fluid in use to provoke cavitation within the dielectric fluid in the gap.

Normally, the vibration is ultrasonic.

Typically, the erosion creates a cavity within the work piece. Generally, the erosion is continuous. Typically, the vibration is fixed or variable within in a range of frequencies. Possibly, the vibration is manually adjustable within the range of frequencies. Alternatively, the arrangement or method incorporates a sensor to determine an erosion factor and there is a controller to receive a signal from the sensor as an indication of the erosion factor and adjust the frequency of the vibration dependent upon the indication of the erosion factor and mass/geometry of the work piece to be machined.

Typically, the electrode is presented upon a servo motor to allow movement of the electrode relative to the work piece. Possibly, a tool holder presents a single electrode. Alternatively, a tool holder presents a multiplicity of electrodes.

Aspects to the present invention will now be described by way of example and reference to the accompanying drawings in which:

FIG. 1 schematically illustrates a typical high-speed electrical discharge machine arrangement;

FIGS. 2a and 2b show prior art worn electrodes;

FIG. 3 shows a section through a turbine blade with undesirable back-wall erosion;

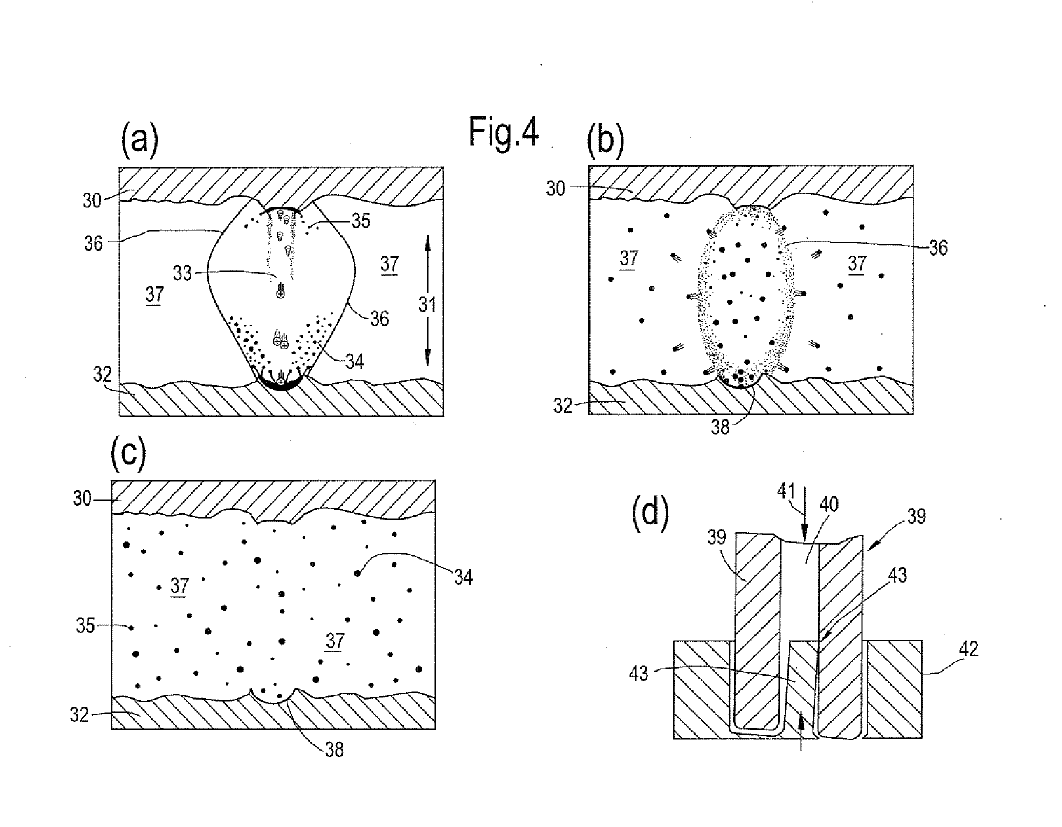

FIG. 4 provides a schematic illustration of stages of the electrical discharge machining process with regard to erosion;

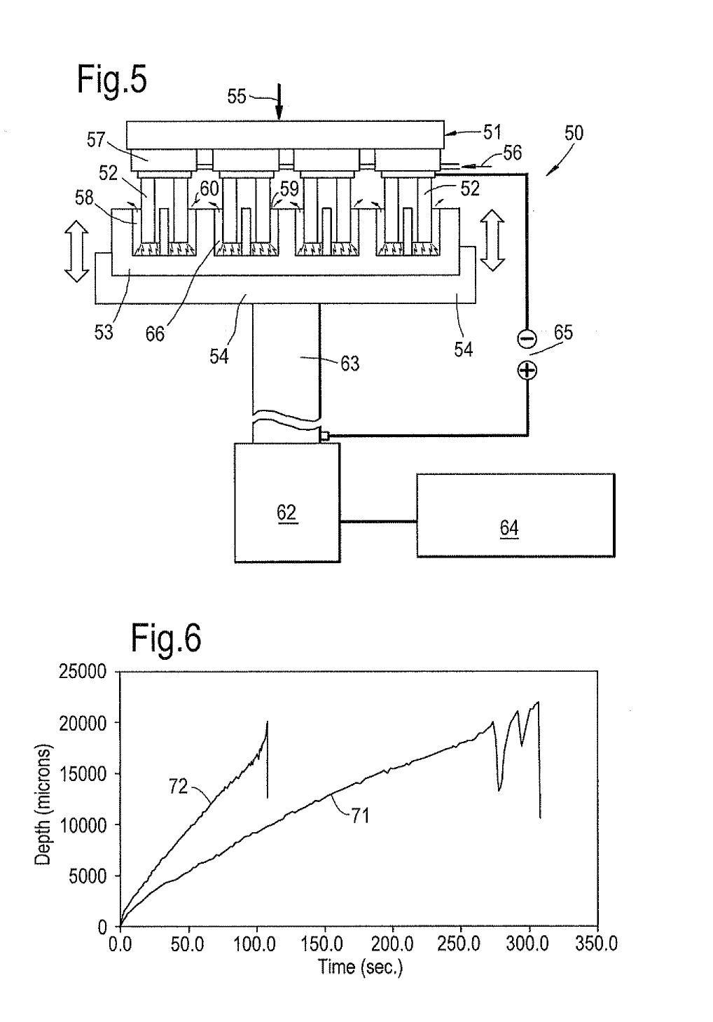

FIG. 5 is a schematic illustration of an electrical discharge machine arrangement in accordance with aspects of the present invention; and,

FIG. 6 is a graphic representation of erosion depth against process time comparing prior electrical discharge machining and electrical discharge machining in accordance with aspects of the present invention.

As indicated above removal of debris is important in order to achieve appropriate machining speeds as well as consistency with such machine processes. Debris is removed by the dielectric flushing out debris in the time between the sparks. This process is illustrated in FIG. 4. When a gas bubble, illustrated in FIG. 4a, is generated by high temperatures as a result of spark discharge this gas bubble will implode as illustrated in FIG. 4b. The time between sparks, known as off time, should be sufficiently long to allow dielectric fluid flushing to remove the debris. The “off time” will determine the overall drilling cycle time for electric discharge machining. Lack of adequate debris removal will result in increased cycle times. Furthermore, poor debris removal increases electrode wear in the form of tapering. In FIG. 4a as can be seen an electrode 30 has a gap 31 to a work piece surface 32. During electrical discharge a plasma channel 33 creates debris 34 from the work piece surface 32 as well as releasing some electrode debris 35. Due to the heat of the spark 33 a bubble 36 is created within the dielectric fluid 37. As indicated previously this dielectric fluid 37 is presented at a relatively high pressure of 70 to 100 bar during high speed dielectric discharge machining.

As illustrated in FIG. 4b during the so called off time the bubble 36 implodes allowing the debris 34, 35 to enter into the dielectric fluid flow 37. During this off time in addition to debris 34, 35 it will also be understood that molten metal is partially removed from a spark generated crater 38. Any molten metal that is not removed solidifies and becomes what is known as a recast layer. Such recast layers can have detrimental effects in terms of surface modifications of the material from which the work piece 32 is formed.

FIG. 4c illustrates the association between the work piece 32 and the electrode 30 just prior to further electrical discharge machining. In such circumstances it will be noted that the debris 34, 35 is held in suspension within the dielectric 37 and therefore will be flushed away under the relatively high pressure provided by high speed electrical discharge machining. Progressively craters 38 will be formed across the surface of the work piece 32 in order to erode and drill as required.

With high speed electrical discharge machining the electrodes used are generally hollow and made from such materials such as brass. One disadvantage of using hollow tubular electrodes is that the core or needle remains in the centre of the hollow tube. In such circumstances the electrode may prematurely retract and lead to a slowing down of a drilling or erosion process. The servo motor retracts because the core of the work piece tilts sideways within the hollow centre of the electrode as it starts to break through and makes contact with the wall of the electrode. It will be understood that as illustrated in FIG. 4d an electrode 39 will have a hollow centre 40 from which a flow of dielectric fluid 41 will pass. The electrode 39 will not evenly break through a work piece 42 and unfortunately a core 43 of the work piece 42 will tilt as the work piece becomes thin and weak to one side of the broken through electrode 39. With such contact between a core 43 and the electrode as indicated monitoring of the gap voltage will result in the servo motor interrupting further processing reducing processing times.

In the above circumstances although high speed electrical discharge machining is advantageous problems and limitations with regard to consistency and erosion/drill speeds as a result of interruptions caused by short circuiting and inadequate removal of debris can limit effectiveness. By aspects of the present invention debris dispersal and minimisation of short circuits are facilitated through use of vibrations and in particular ultrasonic vibration.

Ultrasonic vibrations are generated by the expansion and contraction typically of piezoelectric crystals caused by the application of alternating electrical potential. The expansion and contraction (vibration) takes place at the same frequency as the alternating electrical potential. Use of ultrasonic vibrations is known in a number of industrial processes including those associated with cleaning of parts, welding and laser drilling. Ultrasonic vibrations in a liquid can cause cavitation, that is to say the bubbling or turbulence which may inhibit smooth flow and pressurisation. Vibrations generally facilitate disturbance and agitation.

Aspects of the present invention combine vibration, particularly ultrasonic vibration for example, with the procedures of high speed electrical discharge machining. FIG. 5 provides a schematic illustration of an electrical discharge machining arrangement 50 in accordance with aspects of the present invention. A tool holder 51 presents electrodes 52 to a work piece 53 in a work piece holder 54. The tool holder 51 is manipulated and generally driven in the direction of arrowhead 55 towards the work piece 53 in order to create drilling and erosion as described previously in accordance with electrical discharge machining. In such circumstances a dielectric fluid flow 56 passes through an appropriate distribution system 57 to present dielectric fluid flow in gaps between the electrodes 52 and the work piece 53. This dielectric flow along with debris 58 is presented under pressure. This pressure is generally achieved by a pump (not shown) and is at a pressure in the order of 70 to 100 bar. The flow of dielectric fluid removes the debris created by the electrical discharge machining process in creating cavities and holes 59 in the work piece 53. Generally, the pressurised dielectric fluid flow is presented through a central hollow core of the respective electrodes 52 and passes out of an end into the hole or cavity 59 and then exits in the direction of arrowheads 60.

As indicated above pressurisation of the dielectric fluid flow 56 removes most debris as a result of the electrical discharge machining process but possibly with insufficient speed to avoid transit short circuiting with the result that a servo motor (not shown) presenting the electrode or electrodes may cause a reversing movement in the direction of arrowhead 55 until the short circuit is removed and the debris cleared. A sensor of the erosion process will determine gap voltage as an indication of debris build up.

In accordance with aspects of the present invention the work piece 53 either directly or as illustrated in FIG. 5 through a work piece holder 54 is subject to vibration. In such circumstances the work piece holder 54 acts as a sonotrode if ultrasonic vibration is used.

The sonotrode work piece holder 54 is coupled to a transducer 62 through a booster coupling 63 or otherwise in order to create transfer of ultrasonic vibration in an assembly of at least the work piece 53, electrode 52 and/or the dielectric fluid flow 56. The transducer 62 is coupled to an ultrasonic generator 64 to generate the ultrasonic vibration utilised in accordance with aspects of the present invention.

The ultrasonic generator 64 is generally supplied with an alternating electric current in order to create a range of ultrasonic vibration frequencies utilised to achieve aspects of the present invention. The transducer 62 comprises an electro mechanical component which converts the electrical vibrations from the generator 64 into mechanical vibrations to be coupled to the assembly as described above. The booster 63 is utilised to amplify vibrations leading to a higher vibration (ultrasonic) energy as presented to the assembly. The work piece holder in the form of a sonotrode is a mechanical component which concentrates and transmits efficiently the ultrasonic vibrations to the work piece.

The ultrasonic vibrations are used to augment the debris removal processes of the high speed electrical discharge machining arrangement as described above, that is to say removal of debris promoted by the high pressure dielectric fluid flow. The dielectric fluid as indicated provides isolation between the electrode 52 and the work piece 53 and the high pressure flow acts to flush the debris. An electrical discharge machine generator 65 is used to supply pulses of electrical energy in order to provide the spark discharge in the gap between the electrodes and the work piece for drilling and erosion purposes. The electrode or tool holder acts as a guide to appropriately present the electrode 62 to those parts of the work piece 62 requiring drilling or erosion in accordance with desired machining procedures. The electrodes 62 transmit electrical discharge sparks to the work piece. These discharge sparks cut and erode the work piece to a reciprocal and similar geometry to the presented electrode. As previously the electrodes are effectively presented and associated with a servo motor responsible for feeding the electrode 62 towards and into the work piece 52 ensuring a constant “machining gap” for the desired electrical discharge erosion.

As indicated above a principal problem with respect to prior high speed electrical discharge machining was unpredictability resulting in more than desirable operative intervention and monitoring. It will be understood that there are large number of variables which can affect electrical discharge machining including composition variations in the electrode, composition variations in the dielectric fluid variations in the work piece along with inaccuracies in the EDM Generator and other factors. In such circumstances prior use of high pressure dielectric flow to remove debris may be inadequate. By aspects of the present invention as indicated ultrasonic vibration is introduced into an assembly formed at least in part by the work piece, electrodes and dielectric. The ultrasonic vibrations provoke cavitation in the gap between the electrodes and the work piece that is to say in the pressurised dielectric fluid flow. Such cavitation promotes powerful debris removal and enhanced removal of molten metal from craters left by spark erosion discharge as a result of electrical discharge machining. As indicated removal of such molten metal prior to solidification has benefits with regard to in-service component operational performance. With more effective and complete removal of debris less arcing and short circuits are likely to occur which result in the servo motor retracting the electrodes less to remove the short circuit and allow the debris to be removed. In such circumstances the electrodes can be moved towards the work piece at a constant rate with less likelihood of interruption. Thus, there is more predictability with regard to electrical discharge machining. Furthermore, electrical discharge machining processes can be achieved in shorter time periods.

FIG. 6 provides a graphic illustration of erosion depth against processing time for as shown by line 71 a conventional high speed electrical discharge machine arrangement and for line 72 an electrical discharge machine arrangement combining high speed pressurised dielectric fluid flow and ultrasonic vibration induced cavitation within that flow to enhance debris removal. As can be seen a notional 15,000 micron depth hole can be produced in a much shorter time period than by conventional high speed electrical discharge machinery.

The cavitation induced into the pressurised dielectric fluid flow may effectively scour the work piece surface removing more efficiency molten metal resulting in improvements in the integrity of machine components or work pieces. Furthermore, by introduction of ultrasonic vibration possibilities with regard to “piping” interruptions when cores within the electrode tip touch the electrode as described above with regard to FIG. 5 can be reduced.

The ultrasonic vibrations as indicated induce cavitation bubbles which collapse and release high energy lifting off the debris from the gap. Therefore, the ultrasonic vibrations act in combination with the pressurised dielectric fluid enhancing debris removal. A further consequence of providing ultrasonic vibrations to induce cavitations is reduction in lateral sparking between the electrode and a work piece within a hole or cavity. Lateral sparking results from debris bridging the gap between the side of the electrode and the work piece. Such debris bridging produces tapering and associated differential wear of the electrode. As indicated previously the problems associated with differential types of electrode wear are known. By reducing the accumulation of debris, lateral sparking is reduced and as a consequence apertures and holes drilled or machined in accordance with an electrical discharge machine arrangement in accordance with aspects of the present invention are more consistent. Issues with regard to back wall impingement and a requirement for the dependency on multi-cuts to achieve desired overall features are minimised.

By combining pressurised dielectric fluid flow with ultrasonic vibration induced cavitations in that flow advantages are generally achieved in terms of lower processing times with less variation in those processing times along with reduced electrode wear whether that be differential, tapering or longitudinal. Reduced electrode wear will reduce the cost of electrical discharge machining. More consistency of electrode discharge machining will improve performance in terms of reduced back wall impingements and re-cuts as described previously as well as improved surface integrity of drilled components and work pieces in accordance with aspects of the present invention.

The ultrasonic vibration created by the generator 64 will typically provide a number of fixed vibration frequencies. The choice of the vibration frequency utilised may be manually determined through adjustment over an appropriate range of available frequencies. Alternatively and advantageously, a control mechanism may be used to adjust and vary the vibration frequencies. In such circumstances a closed loop control system will be utilised to alter the adjusted frequency of vibration dependent upon mass, position and geometry of the work piece being machined. In such circumstance by utilisation of an appropriate sensor to determine an erosion factor such as rate of erosion and/or debris concentration and/or other feed back parameter the vibration frequency utilised may be altered.

To enhance the effectiveness of the dielectric fluid it will be understood that additives may be added. These additives may alter the electrical current activity of the dielectric fluid but with particular regard to aspects of the present invention may be utilised to enhance the effect of vibration creating cavitation in the dielectric fluid.

Typically, the work piece will be vibrated as is described above with regard to FIG. 5. However, it will also be understood that additionally within an assembly the electrode either on its own or in association with the work piece may be vibrated in order to create cavitation in the dielectric fluid in the gap between work piece and electrode. In such circumstances the tool or more particularly the tool holder 51 guiding presentation of the electrode 52 may also act as a sonotrode providing ultrasonic vibration in an assembly in accordance with aspects of the present invention.

Typical work pieces which are utilised and processed in accordance with electrical discharge machining in accordance with aspects of the present invention are turbine blades and nozzle guide varies utilised in gas turbine engines. Single or multi-core electrodes may be utilised in order to create cavities and holes in such work pieces as turbine blades. Vibration may be applied to the electrodes which may have a number of geometries including solid electrodes. In the latter case electrode vibration could be controlled by a servo mechanism

Although ultrasonic vibration is preferred it will be appreciated that some or all of the benefits of aspects of the present invention may be provided by providing vibration outside of the ultrasonic frequency ranges in terms of creating cavitation within the dielectric fluid flow and so enhancing debris removal. Such vibration may be applied directly to the work piece or electrodes.

The electrodes may take the form of a wire. In wire electrical discharge machining the electrode as indicated is made from a very fine wire of copper, brass or coated wire. The wire is continually unrolled at a predetermined velocity over guide wires towards the work piece. In wire electrical discharge machining the same presentation processes with regard to the embodiment of aspects of the present invention as described above are utilised. The wire electrode is progressively moved towards the work piece and by aspects of the present invention pressurised dielectric fluid flow as well as vibration induced cavitation is used to enhance debris removal.

It will be appreciated that electrical discharge machining may be used for texturing surfaces. In such circumstances utilisation of vibration in accordance with aspects of the present invention will also allow for efficient removal of debris formed during such processes.

Surface modifications using electrical discharge machining may also benefit from vibration depending on the desired properties it is intended to provide to parts of the material of the work piece. The degree of vibration and in particular ultrasonic vibration may be adjusted to assist with achieving the desired final results.

Engraving of work pieces and components can have a detrimental effect on surface integrity. Such degradation can occur with regard to turbine blades utilised in gas turbines engines where the positioning of any engraved part mark is specified to minimise potential sources of failure of a component. By applying vibration and in particular ultrasonic vibration during any engraving process it may be possible to improve the surface integrity and therefore provide greater flexibility with regard to the position of such engravings on a work piece.

Modifications and alterations to aspects of the present invention will be appreciated by those skilled in the art. Thus, rather than having a single source of vibration multiple sources of vibration may be coupled to a work piece holder and/or a tool holder for an electrode. In such circumstances different forms of vibration can be induced within an assembly of the work piece, electrode and dielectric flow in order to enhance debris removal and operation in accordance with aspects of the present invention.

The method of electrical discharge machining in accordance with aspects of the present invention, generally involves presentation of an electrode to a work piece in an appropriate association typically define by work piece holders and tool holders in a jig. Relative movement between the electrode and the work piece is provided by an appropriate mechanism to ensure an adequate gap is maintained for spark erosion and discharge in accordance with typical electrical discharge machining processes. A dielectric fluid flow is presented at pressure in the gap between the electrode and the work piece as a primary means for flushing and removal of debris as a result of erosion processes. In accordance with aspects of the present invention appropriate vibration induces cavitation within the dielectric fluid flow and is produced to further enhance debris removal. The vibration provided may be of a fixed frequency or adjusted manually or through a control loop in order to control, and normally enhance, debris removal. Thus, if repeated short circuits and therefore retractions to avoid short circuiting and allow debris removal are determined by a controller then adjustments can be made with regard to the dielectric fluid flow pressure, nature of vibration and gap between the work piece and the electrode in order to reduce such interruptions in continuous machining processes.

1. A method for electrical discharge machining comprising presenting an electrode (3, 30, 39, 52) to a work piece (4, 22, 32, 53) with a gap between them to achieve erosion by electrical discharge, the gap filled with a dielectric fluid (7, 56) at a pressure in the range of 70 to 100 bar, the electrode and/or the work piece displaceable to maintain the gap as the electrode wears and the work piece is machined in use, the method characterised in that an assembly of the work piece (53) and/or the electrode (52) and/or the dielectric fluid (56) are subject to vibration to provoke cavitation within the dielectric fluid in the gap.

2. A method as claimed in claim 1 wherein the vibration is ultrasound.

3. A method as claimed in claim 1 or claim 2 wherein the erosion creates a cavity (59) within the work piece.

4. A method as claimed in claim 1, 2 or 3 wherein the erosion is continuous.

5. A method as claimed in any preceding claim wherein the vibration is fixed or variable within a range of frequencies.

6. A method as claimed in any preceding claim wherein the vibration is manually adjustable within the range of frequencies.

7. A method as claimed in any claims 1 to 5 wherein the method incorporates a sensor to determine an erosion factor and a controller to receive a signal from the sensor as an indication of the erosion factor and adjust the frequency of the vibration dependent upon the indication of the erosion factor and mass/geometry of the work piece being machined.

8. A method as claimed in any preceding claim wherein the electrode is presented upon a servo motor (8) to allow movement of the electrode relative to the work piece.

9. A method as claimed in any preceding claim wherein a tool holder (51) presents a single electrode.

10. A method as claimed in any claims 1 to 8 wherein a tool holder (51) presents a multiplicity of electrodes.

11. An electrical discharge machining arrangement comprising an electrode (3, 30, 39, 52), a drive mechanism (8) to maintain a gap between the electrode and the work piece in use, a dielectric source arranged to present a dielectric fluid flow (7, 37, 56) in the gap and maintain the dielectric fluid at a pressure of 70 to 100 bar in the gap, the arrangement characterised in that the arrangement includes a vibration source (64) to present vibration excitation to an assembly of the work piece (53) and/or the electrode (52) and/or dielectric fluid (56) in use to provoke cavitation within the dielectric fluid in the gap.

12. An arrangement as claimed in claim 11 wherein normally the vibration is ultra sound.

13. An arrangements as claimed in claim 11 or claim 12 wherein the erosion creates a cavity (59) within the work piece.

14. An arrangement as claimed in claims 11 to 13 wherein the erosion is continuous.

15. An arrangement as claimed in any of the claims 11 to wherein the vibration is fixed or variable within a range of frequencies.

16. An arrangements as claimed in any of the claims 12 to 15 wherein the vibration is manually adjustable within the range of frequencies.

17. An arrangement as claimed in any of the claims 11 to wherein the arrangement incorporates a sensor to determine an erosion factor and there is a controller to receive a signal from the sensor as an indication of the erosion factor and adjust the frequency of the vibration dependent upon the indication of the erosion factor and mass/geometry of the work piece to be machined.

18. An arrangement as claimed in claim 17 wherein the erosion factor relates to speed erosion and/or concentration of debris within the gap and/or gap voltage.

19. An arrangement as claimed in claims 11 to 18 wherein the electrode is presented upon a servo motor (8) to allow movement of the electrode relative to the work piece.

20. An arrangement as claimed in any claims 11 to 19 wherein a tool holder (51) presents a single electrode.

21. An arrangement as claimed in any claims 11 to 19 wherein a tool holder (51) presents a multiplicity of electrodes.
